(19) United States
(12) Patent Application Publication
(10) Pub. No.: US 2019/0259246 A1
(43) Pub. Date: Aug. 22, 2019

(54) MULTI-GAME VIDEO POKER WAGERING HAVING REPLAY FEATURE

(71) Applicants: Mark Yoseloff, Henderson, NV (US); Russell Brooke Dunn, Henderson, NV (US)

(72) Inventors: Mark Yoseloff, Henderson, NV (US); Russell Brooke Dunn, Henderson, NV (US)

(21) Appl. No.: 15/901,856

(22) Filed: Feb. 21, 2018

(51) Int. Cl. G07F 17/32

(52) U.S. Cl. CPC G07F 17/3293; G07F 17/326; G07F 17/323; G07F 17/3246; G07F 17/3209; G07F 17/3262

(57) ABSTRACT

A method of conducting a video poker game in a single or multi-game format is disclosed. The method offers players an option to draw cards a second time in response to an initial hand meeting certain pre-established requirements. For example, if an initial hand having five cards includes four cards to a royal flush or straight flush, or three cards to a four of a kind, the player may be provided with the second draw opportunity for all of the multiple hands. The player does not necessarily need to place a second wager to redraw. Payouts need not be provided from a second pay table wherein certain payouts are decreased over those found in a pay table associated with one draw outcomes. In some versions, the second draw opportunity is only provided to players placing a first wager meeting or exceeding a minimum threshold value (e.g., maximum coins or units).

### FIELD OF THE INVENTION

The embodiments of the present invention relate to a video poker wagering event in a multi-hand virtual playing card game electronic gaming event having a second chance option whereby a player is afforded a second chance to draw one or more desired cards when a qualifying poker hand rand is provided in at least one initial virtual hand.

### BACKGROUND OF THE ART

Video poker remains a very popular game in casinos and other gaming establishments. Conventional video poker consists of a player placing a wager of one to five coins or units. The player is then shown five cards, from a simulated deck of 52 cards, on a video poker display. The player may then elect which cards to hold and discard. All discards are then replaced with new cards from the deck. The player receives a payout, if any, based on the strength of the poker hand after the draw. However, even with the popularity of video poker, players are often frustrated that they are unable to obtain certain low frequency hands (e.g., royal flush). For example, the probability of hitting or obtaining a royal flush after a single draw is approximately once in every 40,000 hands.

A first electronic gaming system enabled multiple lines of poker gaming events with individual wagers on each gaming event. This gaming event is typically played with 2 to 100 lines of games as enabled in U.S. Pat. No. 5,732,950 (Moody), which evidences dealing multiple rows of five card hands. The player attempts to achieve a high ranking poker hand on the center row by using face up and face down cards as potential replacement cards for the five cards initially dealt to the center row. An alternate method of the present invention involves permitting the player to play up to three hands of video poker at the same time. Other later US Patents issued to Moody on multi-line poker games include the following U.S. Pat. Nos. 5,823,873, 5,976,016, 6,007,066, 6,098,985, 6,561,898, 6,568,680, 6,652,377, 6,878,060, 7,037,190, and the like.

U.S. Pat. No. 7,316,608 (Moody) evidences an electronic gaming event in which the game begins with a player playing a conventional hand of video poker. Whenever the player achieves one of the predetermined types of starting hand combinations on the original round of play of the hand of video poker, then the player is awarded one or more additional hands of video poker on the next round of play. The additional hands of video poker on the next round of play are played according to the multiple hand poker method described in U.S. Pat. Nos. 5,823,873; 6,517,074; 6,050,568 or U.S. Pat. No. 6,135,883. The award of one or more additional hands may continue consecutively as long as the player continues to achieve one of the predetermined types of winning hand combinations on the previous round of play of video poker.

All things being equal, frustrated players tend to play casino games (e.g., video poker) for shorter periods of time than content players. Such shorter play sessions negatively impact the revenue of the casino.

Therefore, it would be advantageous to provide video poker players with multiple draw opportunities to provide players increased chances of obtaining low frequency hands while increasing play sessions and house revenue.

Among efforts to achieve these ends is US Patent Publication 20070298855 (Woodbury) describes a method of conducting a poker game comprising: allowing a player to place a first wager; providing the player with a plurality of random face-up cards forming an initial hand; if the random face-up cards comprise one or more pre-established poker hands, triggering a second draw opportunity; allowing for a first time the player to hold or discard each of the provided random cards; replacing each discard with first new random card; if the second draw opportunity has been triggered, affording the player, for a second wager, a second opportunity to hold or discard one or more of the provided random cards; if the player elects the second draw opportunity, allowing for a second time the player to hold or discard one or more of the provided random cards and replacing each discard with a second new random card; and providing a payout from a two draw pay table to the player based on a rank of a final poker hand.

### SUMMARY OF THE INVENTION

The present invention includes a method of executing a wagering event including single and multiple poker games on an electronic gaming machine. The method includes providing an electronic gaming machine comprising a housing, video display, player input controls, a processor associated with memory, and wherein the player input controls include a value-in-value out component selected from the group consisting of a ticket-in-ticket out system having a ticket reader and a ticket printer with a motor to accept and deliver tickets, and a currency reader with a motor to accept and deliver currency. The processor accepts individual first wagers on a multiple number of individual poker wagering events (the wagers accessing stored credit in the memory associated with the processor). The processor provides each individual poker wagering event displayed on the display screen with identical sets of five random face-up virtual playing cards forming an initial five-card virtual hand. If the random face-up virtual playing cards are recognized by the processor as comprising one or more pre-established minimum poker hand ranks or specific card content, that recognition triggers an available second draw opportunity for the multiple number of individual poker wagering events. The player indicates through the player input controls an election to hold or discard each of the provided random cards so that the recognized pre-established poker hand ranks remains in each of the individual poker wagering events. The processor replaces each discard with first new random cards from individual residual playing card sets from which individual playing cards from which the five random virtual playing cards have been excluded, forming a virtual replacement hand, without having to place any additional wagers on the multiple individual poker wagering events; and the processor resolves all wagers by providing a payout on each of the multiple numbers of replacement hands from a poker pay table to a player credit storage managed by the processor based on a rank of a final poker hand.

### BRIEF DESCRIPTION OF THE DRAWINGS

FIG. 1 shows an electronic gaming machine on which the gaming method of the present invention may be executed.

FIG. 1A shows a schematic for an electronic system for enabling play of the gaming method described herein.

FIG. 1B shows another schematic for an electronic system for enabling play of the gaming method described herein.

FIG. 2A-2E illustrate various pay tables associated with conventional video poker games;

FIG. 3 illustrates a first screen shot of a video poker device according to the embodiments of the present invention;

FIG. 4 illustrates a second screen shot of a video poker device according to the present invention.

FIG. 5 illustrates a third screen shot of a video poker device according to the embodiments of the present invention;

FIG. 6 illustrates a fourth screen shot of a video poker device according to the embodiments of the present invention;

FIG. 7 illustrates a fifth screen shot of a video poker device according to the embodiments of the present invention; and

FIG. 9 shows another prior art pay table.

### DETAILED DESCRIPTION OF THE INVENTION

For the purpose of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would normally occur to one skilled in the relevant art and having possession of this disclosure, are to be considered within the scope of the invention claimed.

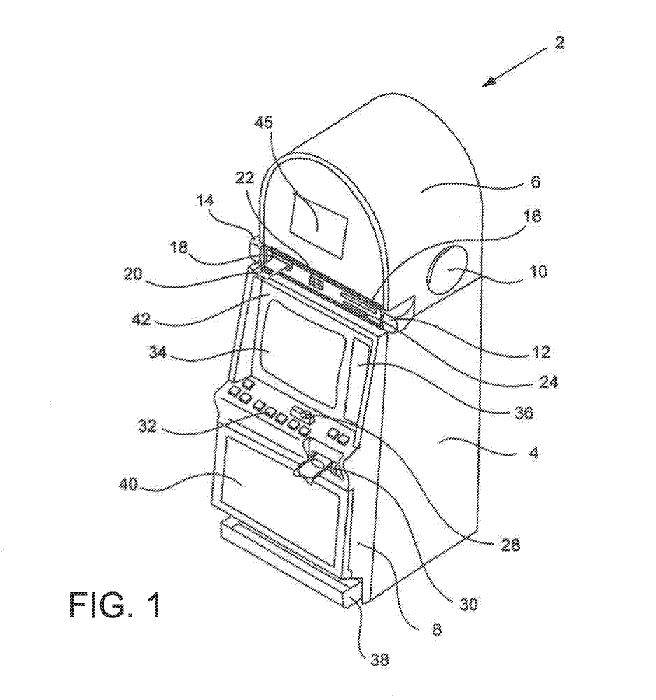

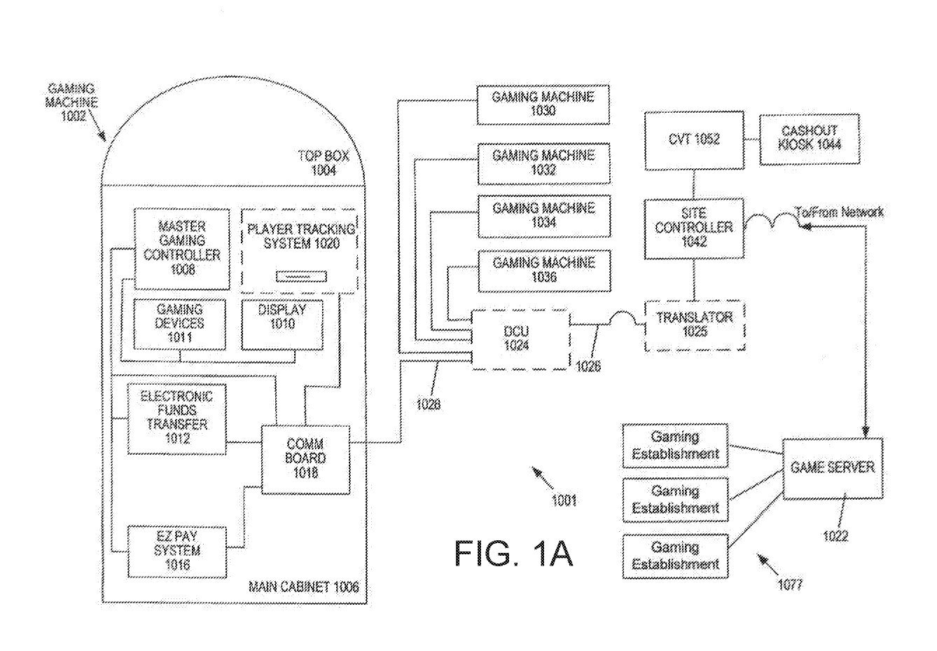

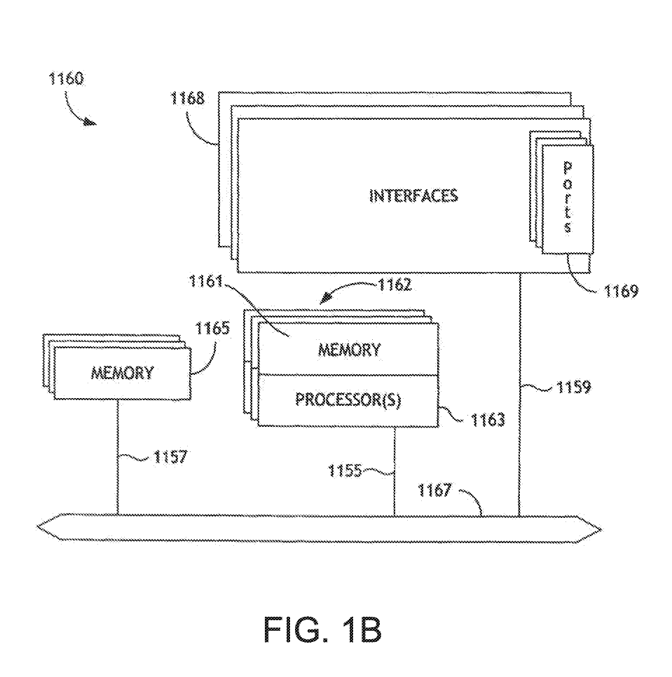

Video poker machines and devices have been in existence for many years. Video poker machines utilize a processor that randomly organizes a deck of simulated or virtual playing cards. Once a wager is placed, the order of the shuffled cards is typically set. Cards are then provided to the player in order off the top of the deck. Reference is now made to the figures wherein like parts are referred to by like numerals throughout. FIG. 1 illustrates an exemplary video poker machine generally referred to by reference numeral.

A first method according to the present invention includes a method of executing a wagering event including one or (preferably) a number of multiple poker games on an electronic gaming machine includes:

providing an electronic gaming machine comprising a housing, video display, player input controls, a processor associated with memory, and wherein the player input controls include a value-in-value out component selected from the group consisting of a ticket-in-ticket out system having a ticket reader and a ticket printer with a motor to accept and deliver tickets, and a currency reader with a motor to accept and deliver currency;

the processor accepting individual first wagers on the one or the number of multiple number of individual poker wagering events;

the processor providing each individual poker wagering event displayed on the display screen with identical sets of five random face-up virtual playing cards forming an initial five-card virtual hand;

the processor executing a first discard and draw event with the player retaining exactly three of four virtual playing cards from the identical sets of five random face-up virtual playing cards to form first final replacement poker hands;

if the random face-up virtual playing cards in the one or the number of multiple poker hands of five random face-up virtual playing cards are recognized by the processor as comprising one or more pre-established poker hand ranks or four of five virtual playing cards necessary to form a straight flush, the processor triggers a second discard and draw event for the one or the number of multiple individual poker wagering events;

the processor discarding and replacing each virtual playing card that is superfluous to the one or more pre-established poker hand ranks or four of five virtual playing cards necessary to form a straight flush of the provided random virtual playing cards in the one or the number of multiple poker hands of five random face-up virtual playing cards so that the recognized pre-established poker hand ranks remains in each of the individual poker wagering events and forming virtual first final replacement hands;

the processor replacing each discard with second new random virtual playing cards from individual residual virtual playing card sets from which individual playing cards from which the five random virtual playing cards have been excluded, forming virtual second final replacement poker hands; and

the processor resolving all wagers by providing a payout on each of the multiple numbers of replacement hands from a poker pay table to a player credit storage managed by the processor based on a rank of at least one of the first final replacement poker hands and the second final replacement poker hands.

There may be a number of multiple poker games and there is a single pay table available for resolution of all wagers in the first final replacement hands and the second final replacement poker hands and the individual first wagers are 6-times a minimum acceptable wager, and the maximum payout in the paytable is based on wagers that are 5-times the minimum acceptable wager.

In the method, second discard and draw activity may be exercised only when a predetermined number of the multiple number of hands in the multiple individual wagering events in excess of zero hands exceeds the one or more pre-established poker hand ranks, and wherein there is a single pay table available for resolution of all wagers in the first final replacement hand and the second final replacement poker hands and the individual first wagers are 6-times a minimum acceptable wager, and the maximum payout in the paytable is based on wagers that are 5-times the minimum acceptable wager. What this means is that the payout for any winning outcomes in both 5-times minimum wagers and 6-times minimum wagers are the same for the same winning poker rank, but that the 6-times minimum poker rank must be used in combination with the predetermined poker ranks or the four-of-five card ranks necessary for a straight flush for the possibility of that event to be triggered. This is an accounting and house percentage win requirements, and not a functional requirement to enable the underlying game events.

A second method of executing a wagering event including multiple poker games on an electronic gaming machine includes:

providing an electronic gaming machine comprising a housing, video display, player input controls, a processor associated with memory, and wherein the player input controls include a value-in-value out component selected from the group consisting of a ticket-in-ticket out system having a ticket reader and a ticket printer with a motor to accept and deliver tickets, and a currency reader with a motor to accept and deliver currency;

the processor accepting at least a predetermined minimum allowable individual first wager on a multiple number of individual poker wagering events;

the processor providing each individual poker wagering event displayed on the video display with identical sets of five random virtual playing cards forming an initial five-card virtual hand identical for each of the multiple number of individual poker wagering events, and displaying such individual initial five-card virtual hands face-up for at least one such individual poker wagering event for each hand on which wagers are placed;

the processor retaining in memory at least until conclusion of the wagering event the values of these initial five random virtual playing cards;

the player identifying through the player input controls which virtual playing cards from the identical sets of five random virtual playing cards are to be maintained to form an initial partial virtual playing card hand and which other virtual playing cards from the identical sets of five random virtual playing cards are to be discarded and replaced by first random virtual replacement playing cards from individual residual virtual playing card sets from which the five initial random virtual playing cards have been excluded, to form first initial final poker hands,

the processor resolving each wager on each of the multiple poker game initial final poker hand ranks against a paytable;

if a subset of the initial random virtual playing cards in the individual initial playing card hands are recognized by the processor as comprising one or more pre-established poker hand ranks or four of five virtual playing cards necessary to form a straight flush, that recognition enables a second deal, discard and draw event for the multiple number of individual poker wagering events of five virtual playing cards identical to the virtual playing cards in the initial five-card virtual hand;

upon initiation of the second deal, discard and draw event by the player, the processor provides each individual original poker wagering event displayed on the video display with a second initial five-card virtual hand with identical suit and rank values of the initial five random virtual playing cards retained in memory, and displays such individual initial five-card virtual hands face-up for at least one such individual poker wagering event for each hand on which wagers in the first deal, discard and draw event have been placed;

the player identifying through the player input controls or the processer duplicates the identified virtual playing cards maintained in the initial five random virtual playing cards which virtual playing cards from the identical sets of five random virtual playing cards are to be maintained to form a second partial virtual playing card hand and which virtual playing cards from the second initial five-card virtual hand are to be discarded and replaced by second random virtual replacement playing cards from individual residual virtual playing card sets from which the five initial random virtual playing cards have been excluded to form second final poker hands,

and the processor resolving all second final poker hands by providing a second payout against a paytable on each of the multiple numbers of second final poker hands based on a rank of all second final poker hands.

Still another method executes a wagering event including multiple poker games on an electronic gaming machine that includes:

providing an electronic gaming machine comprising a housing, video display, player input controls, a processor associated with memory, and wherein the player input controls include a value-in-value out component selected from the group consisting of a ticket-in-ticket out system having a ticket reader and a ticket printer with a motor to accept and deliver tickets, and a currency reader with a motor to accept and deliver currency.

The processor accepts at least a predetermined minimum allowable individual first wager on a multiple number of individual poker wagering events. Preferably a maximum allowable wager (such as 5× an allowable minimum wager of even 6× the allowable minimum wager).

The processor provides each individual poker wagering event displayed on the video display with identical sets of five random virtual playing cards forming an initial five-card virtual hand identical for each of the multiple number of individual poker wagering events, and displaying such individual initial five-card virtual hands face-up for at least one such individual poker wagering event for each hand on which wagers are placed;.

The player identifies through the player input controls which virtual playing cards from the identical sets of five random virtual playing cards are to be maintained to form an initial partial virtual playing card hand and which are to be discarded and replaced by first random virtual replacement playing cards from individual residual virtual playing card sets from which the five initial random virtual playing cards have been excluded, to form first initial final poker hands, the processor resolving each wager on each of the multiple poker game initial final poker hands against a paytable.

if a subset of the initial random virtual playing cards in the individual initial playing card hands are recognized by the processor as comprising one or more pre-established poker hand ranks, that recognition enabling a second deal, discard and draw event for the multiple number of individual poker wagering events;

upon initiation of the second deal, discard and draw event by the player the processor providing each individual original poker wagering event displayed on the video display with the retained original identical sets of five random virtual playing cards forming an initial five-card virtual hand identical for each of the multiple number of individual poker wagering events, and displaying such individual initial five-card virtual hands face-up for at least one such individual poker wagering event for each hand on which wagers in the first deal, discard and draw event are placed; (Alternatively, upon initiation of the second deal, discard and draw event by the player, the processor provides to all of the multiple games the of the 3 or 4 virtual playing cards that form one or more pre-established poker hand ranks or orders of the initial five random virtual playing cards retained in memory, and displaying such individual initial 3 or 4 virtual playing cards face-up for at least one such individual poker wagering event for each hand on which wagers in the first deal, discard and draw event are placed.)

the player identifying through the player input controls which virtual playing cards from the identical sets of five random virtual playing cards are to be maintained to form an second partial virtual playing card hand and which are to be discarded and replaced by second random virtual replacement playing cards from individual residual virtual playing card sets from which the five initial random virtual playing cards have been excluded,

to form second final poker hands and the processor resolving all second final poker hands by providing a second payout against a paytable on each of the multiple numbers of second final poker hands based on a rank of all second final poker hands.

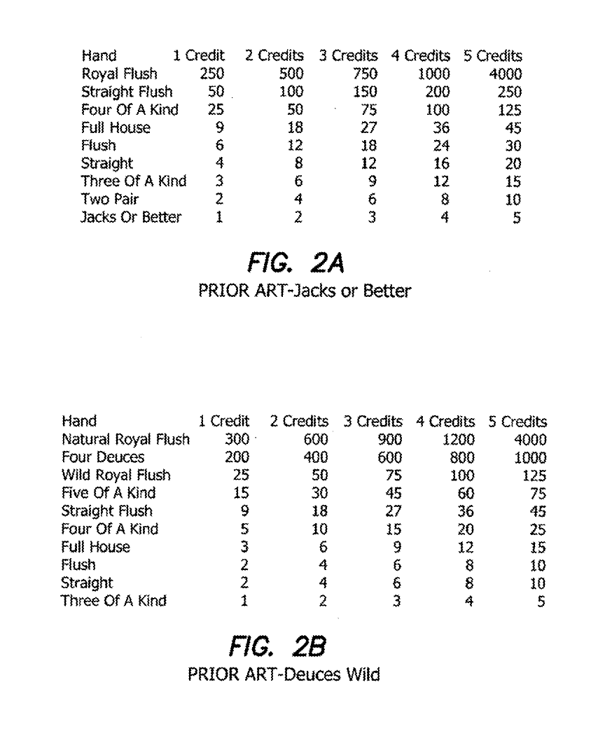

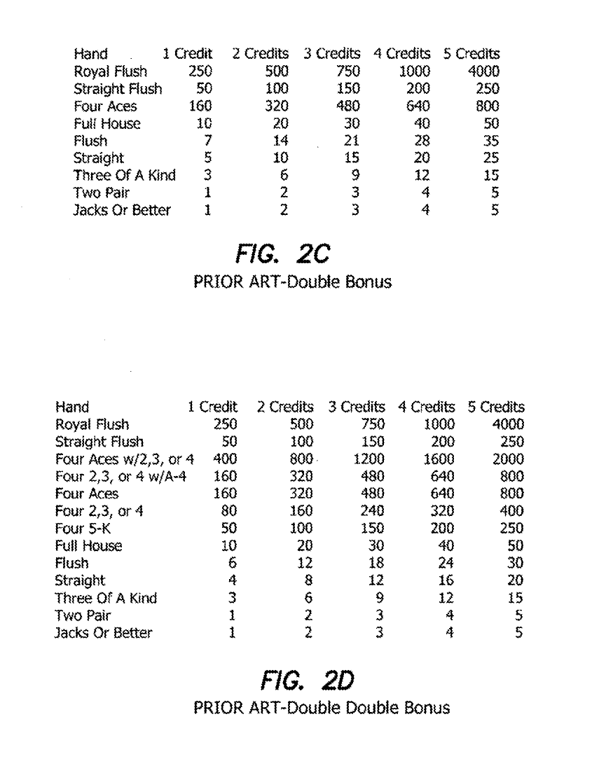

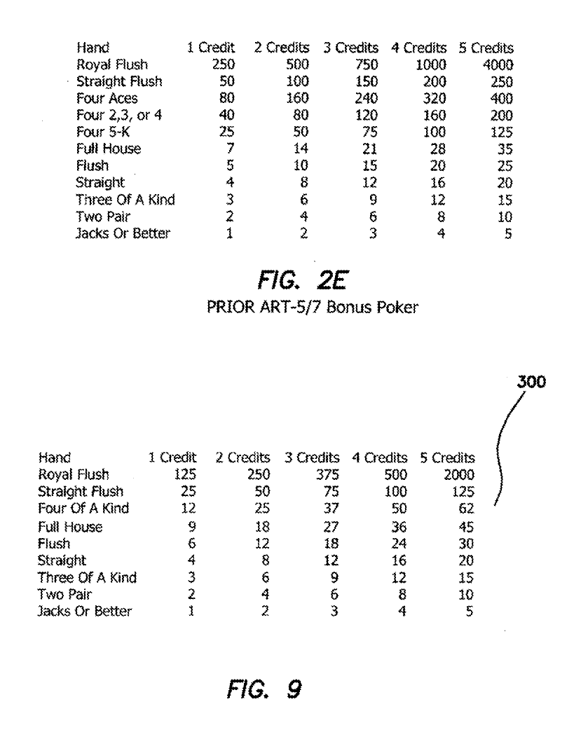

FIGS. 2A-2E show various pay tables associated with different one-draw, video poker games currently on the market. Each of the pay tables has slightly modified payouts based on the game type. More particularly, FIGS. 2A-2E show pay tables for Jacks or Better, Deuces Wild, Double Bonus Poker, Double-Double Bonus Poker and 5/7 Bonus Poker, respectively.

An electronic gaming apparatus with executable software enables a method of executing a wagering event including multiple poker games on an electronic gaming machine. The process includes providing an electronic gaming machine comprising a housing, video display, player input controls, a processor associated with memory, and wherein the player input controls include a value-in-value out component selected from the group consisting of a ticket-in-ticket out system having a ticket reader and a ticket printer with a motor to accept and deliver tickets, and a currency reader with a motor to accept and deliver currency. The ticket-in-ticket-out technology is referred to a TITO in the gaming art.

The processor accepting individual first wagers as a multiple credit amount (such as 6× the minimum wager as compared to the more standard 3× and 5× the minimum wagering amount) for each number of individual poker wagering events (sets of 5 virtual playing cards in each individual virtual hand);

the processor providing each individual poker wagering event displayed on the display screen with identical sets of five random virtual playing cards forming an initial five-card virtual hand and displaying such initial five-card virtual hands face-up for at least one such individual poker wagering event for each hand on which wagers are placed;

if all of the initial first wagers are equal to or exceed some pre-established threshold amount (e.g., 6× the minimum wagering mount) and if the random virtual playing cards are recognized by the processor as comprising one or more pre-established poker hand ranks, that recognition establishes a replay opportunity for the multiple number of individual poker wagering events after a discard and replacement event;

the player indicating through the player input controls an election to hold or discard each (or at least some) of the provided random cards so that the recognized pre-established poker hand ranks remains in each (or at least some) of the individual poker wagering events;

the processor replacing each discard with first new random cards from individual residual playing card sets from which individual playing cards from which the five random virtual playing cards have been excluded, forming a first virtual replacement hand or a first final poker hand;

and the processor resolving all wagers by providing a payout on each of the multiple numbers of replacement hands from a poker pay table to a player credit storage managed by the processor based on a rank of any final poker hand.

In the event that the original five random virtual playing cards established a replay opportunity (e.g., by having no maximum possible hands attained or fewer than a predetermined minimum number of maximum possible hands) and that the virtual replacement hands meet certain pre-established criteria, then upon the completion of the resolution of all hands first final poker hands, and upon the player initiating a new round, a replay round will commence. In the replay round, no additional wagering amount or a reduced wagering amount may be required. The original five virtual playing cards will be dealt again to each individual poker wagering event displayed on the display screen with identical sets of five random virtual playing cards forming an initial five-card virtual hand in each of the hands wagered, or in a fewer number of replay initial hands than originally wagered upon. The play of the hands and the resolution of the hands will be done in the same manner as the original hand, with the residual virtual playing card sets being identical to the residual playing card sets used in the initial round.

The method of the present invention may provide only a single pay table that is available for resolution of all wagers in the initial round and in the replay round. In another embodiment, a separate paytable may be used for the initial round and the replay round This includes differentiations where payout odds on all hands are equal or higher in the initial round and the replay round, or vice versa.

The method may be executed wherein the replay feature applies to all of the multiple individual wagering events regardless of the final outcome of each individual wagering event; alternately, one or more, including all of the multiple individual wagering events may be excluded from the replay round based on the final outcome of such hands exceeding one or more pre-established poker hand ranks. The one or more pre-established poker hand ranks may be selected from the group consisting of Royal Straight Flush, Straight Flush, Four-of-a-Kind and Full House.

By way of non-limiting example, the method may be executed whereby the replay feature is enabled in the event that the identical initial five cards dealt to the multiple individual wagering events comprise one of the following: four of the five cards dealt can be used in forming a Straight Flush, including a Royal Straight Flush; three of the initial five virtual playing cards dealt comprise a Three-of-a-Kind, while all five such cards do not form a Full House; four of the initial cards dealt consist of two pairs, while all five such cards do not form a Full House. The method may also enable the replay event for more or fewer initial identical five card hands dealt to the multiple individual wagering events.

The method may be executed wherein if certain poker ranks are achieved by one or more of the multiple wagering events after receiving the virtual draw cards then the replay feature is no longer active By way of non-limiting examples, if there are three lines in play, the minimum required number may be one hand meeting the preestablished poker hand ranks or status; with five lines in play at least one or two hands meeting the preestablished poker hand ranks or status; with ten lines at least one, two or three hands meeting the preestablished poker hand ranks or status; with twenty-five lines in play, with one, two, three, four or five hands meeting the preestablished poker hand ranks or status; and with fifty or one-hundred lines at least one, two, three, four, five or six meeting the preestablished poker hand ranks or status.

Another way within the scope of the invention of describing a method of executing a wagering event including multiple poker games on an electronic gaming machine including:

providing an electronic gaming machine comprising a housing, video display, player input controls, a processor associated with memory, and wherein the player input controls include a value-in-value out component selected from the group consisting of a ticket-in-ticket out system having a ticket reader and a ticket printer with a motor to accept and deliver tickets, and a currency reader with a motor to accept and deliver currency;

the processor accepting individual first wagers on a multiple number of individual poker wagering events;

the processor providing each individual poker wagering event displayed on the display screen with identical sets of five random virtual playing cards forming an initial five-card virtual hand;

the processor displaying at least one of the sets of virtual playing cards face up;

if all of the initial first wagers are equal to or exceed some pre-established threshold amount and if the random virtual playing cards are recognized by the processor as comprising one or more pre-established poker hand ranks, that recognition establishes a replay opportunity for the multiple number of individual poker wagering events;

the player indicating through the player input controls an election to hold or discard each of the provided random cards so that the recognized pre-established poker hand ranks remains in each (or at least some, as with all hands that did not achieve the maximum possible hands starting with the initial player hands) of the individual poker wagering events;

the processor replacing each discard with first new random cards from individual residual playing card sets from which individual playing cards from which the five initial random virtual playing cards have been excluded (or at least the cards retained are excluded from the residual set of random virtual playing cards), forming a virtual replacement hand;

If the original five random virtual playing cards established a replay opportunity and the virtual replacement hands meet certain pre-established criteria, then upon the completion of the resolution of all hands, and upon the player initiating a new round, a replay round will commence. In the replay round, no wagering or reduced wagering may be required. The original five virtual playing cards will be dealt again to each individual poker wagering event displayed on the display screen with identical sets of five random virtual playing cards forming an initial five-card virtual hand. The play of the hands and the resolution of the hands will be in the same manner as the original hand, with the residual virtual playing card sets being identical to the residual playing card sets used in the initial round.

The method may provide only a single pay table that is available for resolution of all wagers in the initial round and in the replay round. In another embodiment, a separate pay tables may be used for the initial round and the replay round.

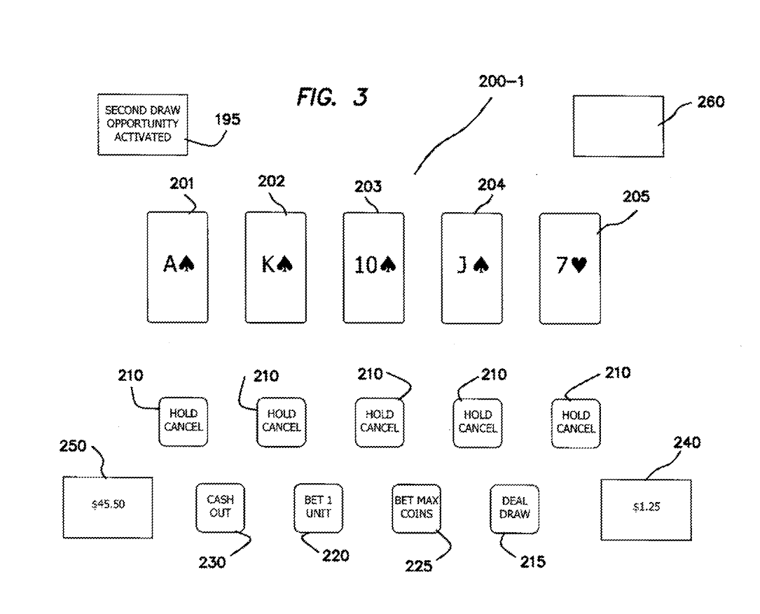

FIG. 3 shows a first screen shot 200-1 of one embodiment of the present invention.

All screen shots are depicted as though touch screen technology has been employed. As shown, the screen shot 200-1 shows hold/discard icons 210, deal/draw icon 220 and cash out icon 230. The screen 200 also provides game information via a number of credits played window 240, showing a $1.25 wager representing maximum coins on a quarter machine, number of total credits available window 250 and a payout window 260. A conventional pay table may also be displayed.

Screen shot 200-1 depicts an initial hand comprising an A 201, K 202, 10 203, J 204 and 7 205. In one embodiment of the present invention, an initial hand comprising four cards to a royal flush or straight flush, or three cards to a four of a kind, activates or triggers a second draw opportunity. Those skilled in the art will understand that any desired initial hand (e.g., four cards to a straight or two pair) may be used to trigger or activate the second draw opportunity. As shown in FIG. 3, the initial hand comprises four cards, namely the A 201, K 202, 10 203 and J 204 to a royal flush. Therefore, the second opportunity draw is triggered internally by the processor allowing the player an opportunity, later during the game, to take advantage of the second draw opportunity. In one embodiment, a second draw opportunity icon 195 appears on the screen to alert the player of the second draw opportunity. It is also conceivable that the second draw opportunity may be limited to players playing maximum coins or units or some other minimum wager threshold. In addition, the second draw opportunity may only be triggered if the player holds the triggering cards (e.g., four cards to the Royal) after the initial hand and during the second hand.

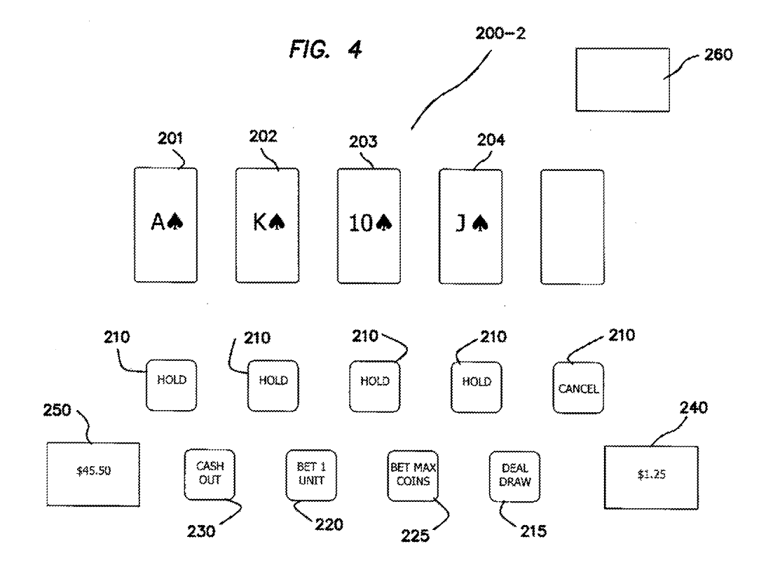

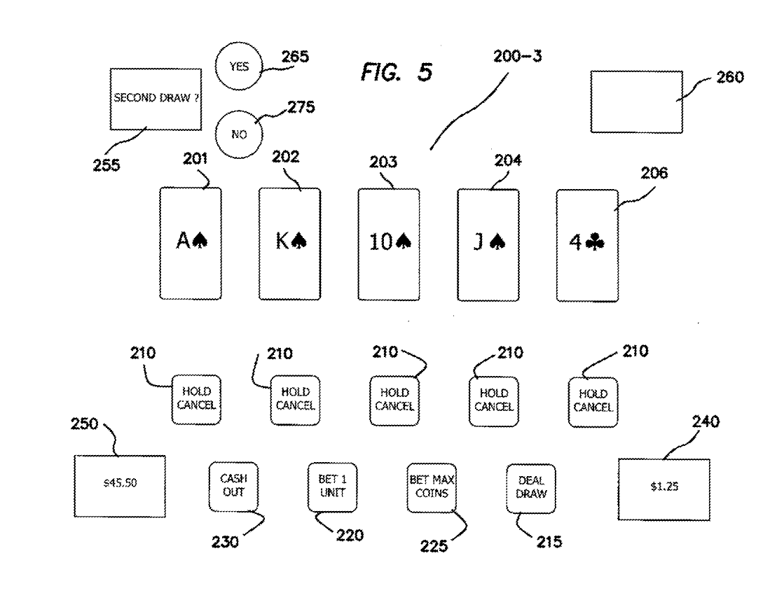

FIG. 4 shows a second screen shot 200-2 after the player has elected to hold the four cards to the royal flush and discard the 7 205. FIG. 5 shows a third screen shot 200-3 depicting a replacement card 4 206 having been dealt to the player in place of the discard 205. As the player did not obtain the royal flush, the player may, based on the initial dealt hand, take advantage of the second draw opportunity. A “Second Draw?” query icon 255 is presented to the player. To elect the second draw opportunity the player presses the “Yes” icon 265 and/or places a second wager and to decline the player may press the “no” icon 275. Ideally, the second wager is equal to the first wager. In this instance, the second wager is $1.25 equaling the first wager as reflected in window 240. Alternatively, the amount of the required second wager may be greater than or less than the first wager.

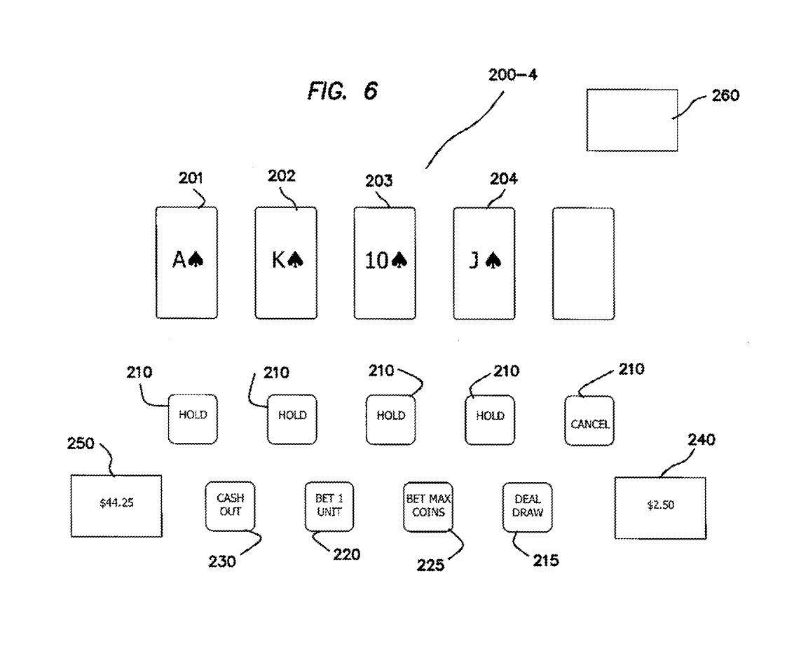

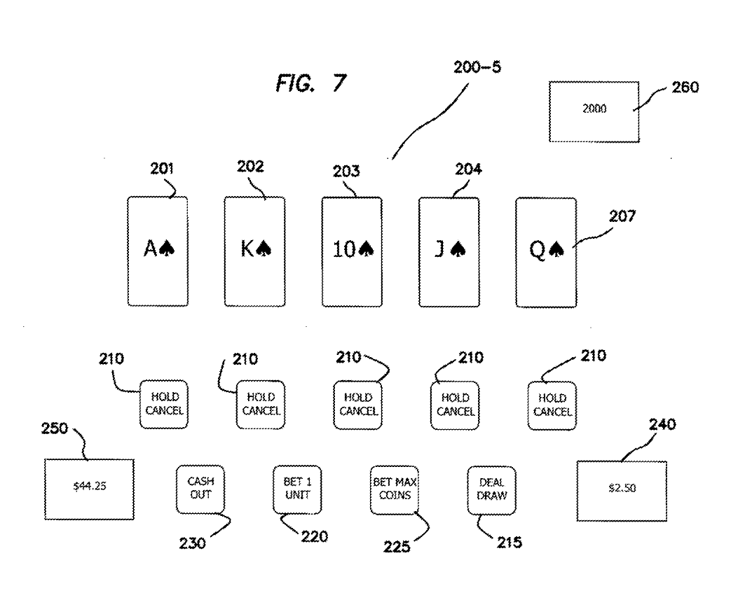

FIG. 6 shows a fourth screen shot 200-4 after the player has deposited the second wager (the credits played window 240 shows the first and second wager and the total credits available window 250 shows the $1.25 deducted) to participate in the second draw opportunity and elected to hold the four cards to the royal flush and discard the 4 206. As shown in screen shot 200-5 of FIG. 7, the player has now been provided with the Q 207 to form a royal flush. As the player opted to utilize the second draw opportunity, the player is paid according to an alternative pay table 300 shown in FIG. 9. The two draw pay table 300 is shown optionally including decreased payouts for those hands, namely the royal flush, straight flush and four of kind, which, based on the second draw, have an increased chance of being obtained by the player. As shown, the royal flush payout 301, straight flush payout 302 and four of a kind payout 303 have been decreased by approximately 50% over the corresponding payouts in the conventional pay tables shown in FIGS. 2A-2E. The payout of 2000 coins or units is reflected in payout window 260. Those skilled in the art will recognize that the payouts may be modified according to a different percentage as long as the pay table 300 provides a suitable house edge or advantage. Moreover, if other initial hands are used to trigger the second draw opportunity, payouts related to other final hands may be modified as well.

After the player completes the first draw, the resultant poker hand may be a winning hand while not being the target hand. For example, a player being dealt the initial hand shown in FIG. 3 would elect to hold the A 201, K 202, 10 203 and J 204 and discard the 7 205 to try for the royal flush. On the draw, the 7 205 may be replaced with another spade but not the Q such that the resultant hand is a flush which has a corresponding payout in all video poker pay tables. Depending on the embodiment of the game, the player may be permitted to retain the flush payout and then place a second wager to try and obtain the royal flush or other winning outcome (e.g., another flush) or the player may be required to forfeit the first payout for the opportunity to try a second time at obtaining a royal flush.

Variations in the technology might include one or more of the following. Including wild symbols that will automatically complete the best possible word. Multiline game (five or nine paying lines instead of just three). No holding (players just spin and win). Game math could be completed using Template algorithm (see U.S. Pat. Nos. 6,117,009 and 6,159,096 (Yoseloff), which are incorporated herein in their entirety. Game math could simply assign different probabilities for each letter for each row. (For example, increasing the probability of a Q landing on the 5^{th} reel would disqualify any possible 5-letter word from being formed.

Another gaming network that may be used to implement some aspects of the invention is depicted in FIG. 1A. Gaming establishment 1001 could be any sort of gaming establishment, such as a casino, a card room, an airport, a store, etc. In this example, gaming network 1077 includes more than one gaming establishment, all of which are networked to game server 1022. Here, gaming machine 1002, and the other gaming machines 1030, 1032, 1034, and 1036, include a main cabinet 1006 and a top box 1004. The main cabinet 1006 houses the main gaming elements and can also house peripheral systems, such as those that utilize dedicated gaming networks. The top box 1004 may also be used to house these peripheral systems.

The master gaming controller 1008 controls the game play on the gaming machine 1002 according to instructions and/or game data from game server 1022 or stored within gaming machine 1002 and receives or sends data to various input/output devices 1011 on the gaming machine 1002. In one embodiment, master gaming controller 1008 includes processor(s) and other apparatus of the gaming machines described above. The master gaming controller 1008 may also communicate with a display 1010.

A particular gaming entity may desire to provide network gaming services that provide some operational advantage. Thus, dedicated networks may connect gaming machines to host servers that track the performance of gaming machines under the control of the entity, such as for accounting management, electronic fund transfers (EFTs), cashless ticketing, such as EZPay™, marketing management, and data tracking, such as player tracking. Therefore, master gaming controller 1008 may also communicate with EFT system 1012, EZPay™ system, and player tracking system 1020. The systems of the gaming machine 1002 communicate the data onto the network 1022 via a communication board 1018.

It will be appreciated by those of skill in the art that embodiments of the present invention could be implemented on a network with more or fewer elements than are depicted in FIG. 1A. For example, player tracking system 1020 is not a necessary feature of some implementations of the present invention. However, player tracking programs may help to sustain a game player's interest in additional game play during a visit to a gaming establishment and may entice a player to visit a gaming establishment to partake in various gaming activities. Player tracking programs provide rewards to players that typically correspond to the player's level of patronage (e.g., to the player's playing frequency and/or total amount of game plays at a given casino). Player tracking rewards may be free meals, free lodging and/or free entertainment. Player tracking information may be combined with other information that is now readily obtainable by an SBG system.

Moreover, DCU 1024 and translator 1025 are not required for all gaming establishments 1001. However, due to the sensitive nature of much of the information on a gaming network (e.g., electronic fund transfers and player tracking data) the manufacturer of a host system usually employs a particular networking language having proprietary protocols. For instance, 10-20 different companies produce player tracking host systems where each host system may use different protocols. These proprietary protocols are usually considered highly confidential and not released publicly.

Further, gaming machines are made by many different manufacturers. The communication protocols on the gaming machine are typically hard-wired into the gaming machine and each gaming machine manufacturer may utilize a different proprietary communication protocol. A gaming machine manufacturer may also produce host systems, in which case their gaming machines are compatible with their own host systems. However, in a heterogeneous gaming environment, gaming machines from different manufacturers, each with its own communication protocol, may be connected to host systems from other manufacturers, each with another communication protocol. Therefore, communication compatibility issues regarding the protocols used by the gaming machines in the system and protocols used by the host systems must be considered.

A network device that links a gaming establishment with another gaming establishment and/or a central system will sometimes be referred to herein as a “site controller.” Here, site controller 1042 provides this function for gaming establishment 1001. Site controller 1042 is connected to a central system and/or other gaming establishments via one or more networks, which may be public or private networks. Among other things, site controller 1042 communicates with game server 1022 to obtain game data, such as ball drop data, bingo card data, etc.

In the present illustration, gaming machines 1002, 1030, 1032, 1034 and 1036 are connected to a dedicated gaming network 1022. In general, the DCU 1024 functions as an intermediary between the different gaming machines on the network 1022 and the site controller 1042. In general, the DCU 1024 receives data transmitted from the gaming machines and sends the data to the site controller 1042 over a transmission path 1026. In some instances, when the hardware interface used by the gaming machine is not compatible with site controller 1042, a translator 1025 may be used to convert serial data from the DCU 1024 to a format accepted by site controller 1042. The translator may provide this conversion service to a plurality of DCUs.

Further, in some dedicated gaming networks, the DCU 1024 can receive data transmitted from site controller 1042 for communication to the gaming machines on the gaming network. The received data may be, for example, communicated synchronously to the gaming machines on the gaming network.

Here, CVT 1052 provides cashless and cashout gaming services to the gaming machines in gaming establishment 1001. Broadly speaking, CVT 1052 authorizes and validates cashless gaming machine instruments (also referred to herein as “tickets” or “vouchers”), including but not limited to tickets for causing a gaming machine to display a game result and cash-out tickets. Moreover, CVT 1052 authorizes the exchange of a cashout ticket for cash. These processes will be described in detail below. In one example, when a player attempts to redeem a cash-out ticket for cash at cashout kiosk 1044, cash out kiosk 1044 reads validation data from the cashout ticket and transmits the validation data to CVT 1052 for validation. The tickets may be printed by gaming machines, by cashout kiosk 1044, by a stand-alone printer, by CVT 1052, etc. Some gaming establishments will not have a cashout kiosk 1044. Instead, a cashout ticket could be redeemed for cash by a cashier (e.g. of a convenience store), by a gaming machine or by a specially configured CVT.

FIG. 1B illustrates an example of a network device that may be configured for implementing some methods of the present invention. Network device 1160 includes a master central processing unit (CPU) 1162, interfaces 1168, and a bus 1167 (e.g., a PCI bus). Generally, interfaces 1168 include ports 1169 appropriate for communication with the appropriate media. In some embodiments, one or more of interfaces 1168 includes at least one independent processor and, in some instances, volatile RAM. The independent processors may be, for example, ASICs or any other appropriate processors. According to some such embodiments, these independent processors perform at least some of the functions of the logic described herein. In some embodiments, one or more of interfaces 1168 control such communications-intensive tasks as encryption, decryption, compression, decompression, packetization, media control and management. By providing separate processors for the communications-intensive tasks, interfaces 1168 allow the master microprocessor 1162 efficiently to perform other functions such as routing computations, network diagnostics, security functions, etc.

The interfaces 1168 are typically provided as interface cards (sometimes referred to as “linecards”). Generally, interfaces 1168 control the sending and receiving of data packets over the network and sometimes support other peripherals used with the network device 1160. Among the interfaces that may be provided are FC interfaces, Ethernet interfaces, frame relay interfaces, cable interfaces, DSL interfaces, token ring interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like.

When acting under the control of appropriate software or firmware, in some implementations of the invention CPU 1162 may be responsible for implementing specific functions associated with the functions of a desired network device. According to some embodiments, CPU 1162 accomplishes all these functions under the control of software including an operating system and any appropriate applications software.

CPU 1162 may include one or more processors 1163 such as a processor from the Motorola family of microprocessors or the MIPS family of microprocessors. In an alternative embodiment, processor 1163 is specially designed hardware for controlling the operations of network device 1160. In a specific embodiment, a memory 1161 (such as non-volatile RAM and/or ROM) also forms part of CPU 1162. However, there are many different ways in which memory could be coupled to the system. Memory block 1161 may be used for a variety of purposes such as, for example, caching and/or storing data, programming instructions, etc.

Regardless of network device's configuration, it may employ one or more memories or memory modules (such as, for example, memory block 1165) configured to store data, program instructions for the general-purpose network operations and/or other information relating to the functionality of the techniques described herein. The program instructions may control the operation of an operating system and/or one or more applications, for example.

Because such information and program instructions may be employed to implement the systems/methods described herein, the present invention also relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files containing higher-level code that may be executed by the computer using an interpreter.

Although the system shown in FIG. 1B illustrates one specific network device of the present invention, it is by no means the only network device architecture on which the present invention can be implemented. For example, an architecture having a single processor that handles communications as well as routing computations, etc. is often used. Further, other types of interfaces and media could also be used with the network device. The communication path between interfaces may be bus based (as shown in FIG. 1B) or switch fabric based (such as a cross-bar).

Another gaming network that may be used to implement some aspects of the invention is depicted in FIG. 1A. Gaming establishment 1001 could be any sort of gaming establishment, such as a casino, a card room, an airport, a store, etc. In this example, gaming network 1077 includes more than one gaming establishment, all of which are networked to game server 1022.

Here, gaming machine 1002, and the other gaming machines 1030, 1032, 1034, and 1036, include a main cabinet 1006 and a top box 1004. The main cabinet 1006 houses the main gaming elements and can also house peripheral systems, such as those that utilize dedicated gaming networks. The top box 1004 may also be used to house these peripheral systems.

The master gaming controller 1008 controls the game play on the gaming machine 1002 according to instructions and/or game data from game server 1022 or stored within gaming machine 1002 and receives or sends data to various input/output devices 1011 on the gaming machine 1002. In one embodiment, master gaming controller 1008 includes processor(s) and other apparatus of the gaming machines described above. The master gaming controller 1008 may also communicate with a display 1010.

A particular gaming entity may desire to provide network gaming services that provide some operational advantage. Thus, dedicated networks may connect gaming machines to host servers that track the performance of gaming machines under the control of the entity, such as for accounting management, electronic fund transfers (EFTs), cashless ticketing, such as EZPay™, marketing management, and data tracking, such as player tracking. Therefore, master gaming controller 1008 may also communicate with EFT system 1012, EZPay™ system, and player tracking system 1020. The systems of the gaming machine 1002 communicate the data onto the network 1022 via a communication board 1018.

It will be appreciated by those of skill in the art that embodiments of the present invention could be implemented on a network with more or fewer elements than are depicted in FIG. 1A. For example, player tracking system 1020 is not a necessary feature of some implementations of the present invention. However, player tracking programs may help to sustain a game player's interest in additional game play during a visit to a gaming establishment and may entice a player to visit a gaming establishment to partake in various gaming activities. Player tracking programs provide rewards to players that typically correspond to the player's level of patronage (e.g., to the player's playing frequency and/or total amount of game plays at a given casino). Player tracking rewards may be free meals, free lodging and/or free entertainment. Player tracking information may be combined with other information that is now readily obtainable by an SBG system.

Moreover, DCU 1024 and translator 1025 are not required for all gaming establishments 1001. However, due to the sensitive nature of much of the information on a gaming network (e.g., electronic fund transfers and player tracking data) the manufacturer of a host system usually employs a particular networking language having proprietary protocols. For instance, 10-20 different companies produce player tracking host systems where each host system may use different protocols. These proprietary protocols are usually considered highly confidential and not released publicly.

Further, gaming machines are made by many different manufacturers. The communication protocols on the gaming machine are typically hard-wired into the gaming machine and each gaming machine manufacturer may utilize a different proprietary communication protocol. A gaming machine manufacturer may also produce host systems, in which case their gaming machines are compatible with their own host systems. However, in a heterogeneous gaming environment, gaming machines from different manufacturers, each with its own communication protocol, may be connected to host systems from other manufacturers, each with another communication protocol. Therefore, communication compatibility issues regarding the protocols used by the gaming machines in the system and protocols used by the host systems must be considered.

A network device that links a gaming establishment with another gaming establishment and/or a central system will sometimes be referred to herein as a “site controller.” Here, site controller 1042 provides this function for gaming establishment 1001. Site controller 1042 is connected to a central system and/or other gaming establishments via one or more networks, which may be public or private networks. Among other things, site controller 1042 communicates with game server 1022 to obtain game data, such as ball drop data, bingo card data, etc.

In the present illustration, gaming machines 1002, 1030, 1032, 1034 and 1036 are connected to a dedicated gaming network 1022. In general, the DCU 1024 functions as an intermediary between the different gaming machines on the network 1022 and the site controller 1042. In general, the DCU 1024 receives data transmitted from the gaming machines and sends the data to the site controller 1042 over a transmission path 1026. In some instances, when the hardware interface used by the gaming machine is not compatible with site controller 1042, a translator 1025 may be used to convert serial data from the DCU 1024 to a format accepted by site controller 1042. The translator may provide this conversion service to a plurality of DCUs.

Further, in some dedicated gaming networks, the DCU 1024 can receive data transmitted from site controller 1042 for communication to the gaming machines on the gaming network. The received data may be, for example, communicated synchronously to the gaming machines on the gaming network.

Here, CVT 1052 provides cashless and cashout gaming services to the gaming machines in gaming establishment 1001. Broadly speaking, CVT 1052 authorizes and validates cashless gaming machine instruments (also referred to herein as “tickets” or “vouchers”), including but not limited to tickets for causing a gaming machine to display a game result and cash-out tickets. Moreover, CVT 1052 authorizes the exchange of a cashout ticket for cash. These processes will be described in detail below. In one example, when a player attempts to redeem a cash-out ticket for cash at cashout kiosk 1044, cash out kiosk 1044 reads validation data from the cashout ticket and transmits the validation data to CVT 1052 for validation. The tickets may be printed by gaming machines, by cashout kiosk 1044, by a stand-alone printer, by CVT 1052, etc. Some gaming establishments will not have a cashout kiosk 1044. Instead, a cashout ticket could be redeemed for cash by a cashier (e.g. of a convenience store), by a gaming machine or by a specially configured CVT.

FIG. 1B illustrates an example of a network device that may be configured for implementing some methods of the present invention. Network device 1160 includes a master central processing unit (CPU) 1162, interfaces 1168, and a bus 1167 (e.g., a PCI bus). Generally, interfaces 1168 include ports 1169 appropriate for communication with the appropriate media. In some embodiments, one or more of interfaces 1168 includes at least one independent processor and, in some instances, volatile RAM. The independent processors may be, for example, ASICs or any other appropriate processors. According to some such embodiments, these independent processors perform at least some of the functions of the logic described herein. In some embodiments, one or more of interfaces 1168 control such communications-intensive tasks as encryption, decryption, compression, decompression, packetization, media control and management. By providing separate processors for the communications-intensive tasks, interfaces 1168 allow the master microprocessor 1162 efficiently to perform other functions such as routing computations, network diagnostics, security functions, etc.

The interfaces 1168 are typically provided as interface cards (sometimes referred to as “linecards”). Generally, interfaces 1168 control the sending and receiving of data packets over the network and sometimes support other peripherals used with the network device 1160. Among the interfaces that may be provided are FC interfaces, Ethernet interfaces, frame relay interfaces, cable interfaces, DSL interfaces, token ring interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like.

When acting under the control of appropriate software or firmware, in some implementations of the invention CPU 1162 may be responsible for implementing specific functions associated with the functions of a desired network device. According to some embodiments, CPU 1162 accomplishes all these functions under the control of software including an operating system and any appropriate applications software.

CPU 1162 may include one or more processors 1163 such as a processor from the Motorola family of microprocessors or the MIPS family of microprocessors. In an alternative embodiment, processor 1163 is specially designed hardware for controlling the operations of network device 1160. In a specific embodiment, a memory 1161 (such as non-volatile RAM and/or ROM) also forms part of CPU 1162. However, there are many different ways in which memory could be coupled to the system. Memory block 1161 may be used for a variety of purposes such as, for example, caching and/or storing data, programming instructions, etc.

Regardless of network device's configuration, it may employ one or more memories or memory modules (such as, for example, memory block 1165) configured to store data, program instructions for the general-purpose network operations and/or other information relating to the functionality of the techniques described herein. The program instructions may control the operation of an operating system and/or one or more applications, for example.

Because such information and program instructions may be employed to implement the systems/methods described herein, the present invention also relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files containing higher-level code that may be executed by the computer using an interpreter.

Although the system shown in FIG. 1B illustrates one specific network device of the present invention, it is by no means the only network device architecture on which the present invention can be implemented. For example, an architecture having a single processor that handles communications as well as routing computations, etc. is often used. Further, other types of interfaces and media could also be used with the network device. The communication path between interfaces may be bus based (as shown in FIG. 1B) or switch fabric based (such as a cross-bar).

Turning next to FIG. 1, a video gaming machine 2 of the present invention is shown. Machine 2 includes a main cabinet 4, which generally surrounds the machine interior (not shown) and is viewable by users. The main cabinet includes a main door 8 on the front of the machine, which opens to provide access to the interior of the machine. Attached to the main door are player-input switches or buttons 32, a coin acceptor 28, and a bill validator 30, a coin tray 38, and a display area including a mechanical gaming system (or less preferably a separate electronic game) 40. There may be an overlay of touchscreen functionality on the separate electronic game 40 or some of the buttons 32 may be functional on the separate mechanical gaming system 40. That separate mechanical gaming system may be in a relatively vertical viewing position as shown, or in a more horizontal (table like) display unit, Viewable through the main door is a video display monitor 34 and an information panel 36. The display monitor 34 will typically be a cathode ray tube, high resolution flat-panel LCD, LED, plasma screen or other conventional electronically controlled video monitor. The information panel 36 may be a back-lit, silk screened glass panel with lettering to indicate general game information including, for example, a game denomination (e.g. $0.25 or $1). The bill validator 30, player-input switches 32, video display monitor 34, and information panel are devices used to play a game on the game machine 2. The devices are controlled by circuitry (e.g. the master gaming controller) housed inside the main cabinet 4 of the machine 2.

Many different types of games, including mechanical slot games, video slot games, video poker, video black jack, video pachinko and lottery, may be provided with gaming machines of this invention. In particular, the gaming machine 2 may be operable to provide a play of many different instances of games of chance. The instances may be differentiated according to themes, sounds, graphics, type of game (e.g., slot game vs. card game), denomination, number of paylines, maximum jackpot, progressive or non-progressive, bonus games, etc. The gaming machine 2 may be operable to allow a player to select a game of chance to play from a plurality of instances available on the gaming machine. For example, the gaming machine may provide a menu with a list of the instances of games that are available for play on the gaming machine and a player may be able to select from the list a first instance of a game of chance that they wish to play.

The various instances of games available for play on the gaming machine 2 may be stored as game software on a mass storage device in the gaming machine or may be generated on a remote gaming device but then displayed on the gaming machine. The gaming machine 2 may executed game software, such as but not limited to video streaming software that allows the game to be displayed on the gaming machine. When an instance is stored on the gaining machine 2, it may be loaded from the mass storage device into a RAM for execution. In some cases, after a selection of an instance, the game software that allows the selected instance to be generated may be downloaded from a remote gaming device, such as another gaming machine.

The gaming machine 2 includes a top box 6, which sits on top of the main cabinet 4. The top box 6 houses a number of devices, which may be used to add features to a game being played on the gaming machine 2, including speakers 10, 12, 14, a ticket printer 18 which prints bar-coded tickets 20, a key pad 22 for entering player tracking information, a florescent display 16 for displaying player tracking information, a card reader 24 for entering a magnetic striped card containing player tracking information, and a video display screen 42. The ticket printer 18 may be used to print tickets for a cashless ticketing system. Further, the top box 6 may house different or additional devices than shown in the FIG. 1. For example, the top box may contain a bonus wheel or a back-lit silk screened panel which may be used to add bonus features to the game being played on the gaming machine. As another example, the top box may contain a display for a progressive jackpot offered on the gaming machine. During a game, these devices are controlled and powered, in part, by circuitry (e.g. a master gaming controller) housed within the main cabinet 4 of the machine 2.

Understand that gaming machine 2 is but one example from a wide range of gaming machine designs on which the present invention may be implemented. For example, not all suitable gaming machines have top boxes or player tracking features. Further, some gaming machines have only a single game display—mechanical or video, while others are designed for bar tables and have displays that face upwards. As another example, a game may be generated in on a host computer and may be displayed on a remote terminal or a remote gaming device. The remote gaming device may be connected to the host computer via a network of some type such as a local area network, a wide area network, an intranet or the Internet. The remote gaming device may be a portable gaming device such as but not limited to a cell phone, a personal digital assistant, and a wireless game player. Images rendered from 3-D gaming environments may be displayed on portable gaming devices that are used to play a game of chance. Further a gaming machine or server may include gaming logic for commanding a remote gaming device to render an image from a virtual camera in a 3-D gaming environments stored on the remote gaming device and to display the rendered image on a display located on the remote gaming device. Thus, those of skill in the art will understand that the present invention, as described below, can be deployed on most any gaming machine now available or hereafter developed.

Some preferred gaming machines are implemented with special features and/or additional circuitry that differentiates them from general-purpose computers (e.g., desktop PCs and laptops). Gaming machines are highly regulated to ensure fairness and, in many cases, gaming machines are operable to dispense monetary awards of multiple millions of dollars. Therefore, to satisfy security and regulatory requirements in a gaming environment, hardware and software architectures may be implemented in gaming machines that differ significantly from those of general-purpose computers. A description of gaming machines relative to general-purpose computing machines and some examples of the additional (or different) components and features found in gaming machines are described below.

At first glance, one might think that adapting PC technologies to the gaining industry would be a simple proposition because both PCs and gaming machines employ microprocessors that control a variety of devices. However, because of such reasons as 1) the regulatory requirements that are placed upon gaming machines, 2) the harsh environment in which gaming machines operate, 3) security requirements and 4) fault tolerance requirements, adapting PC technologies to a gaming machine can be quite difficult. Further, techniques and methods for solving a problem in the PC industry, such as device compatibility and connectivity issues, might not be adequate in the gaming environment. For instance, a fault or a weakness tolerated in a PC, such as security holes in software or frequent crashes, may not be tolerated in a gaming machine because in a gaming machine these faults can lead to a direct loss of funds from the gaming machine, such as stolen cash or loss of revenue when the gaming machine is not operating properly.

For the purposes of illustration, a few differences between PC systems and gaming systems will be described. A first difference between gaming machines and common PC based computers systems is that gaming machines are designed to be state-based systems. In a state-based system, the system stores and maintains its current state in a non-volatile memory, such that, in the event of a power failure or other malfunction the gaining machine will return to its current state when the power is restored. For instance, if a player was shown an award for a game of chance and, before the award could be provided to the player the power failed, the gaming machine, upon the restoration of power, would return to the state where the award is indicated. As anyone who has used a PC, knows, PCs are not state machines and a majority of data is usually lost when a malfunction occurs. This requirement affects the software and hardware design on a gaming machine.

A second important difference between gaming machines and common PC based computer systems is that for regulation purposes, the software on the gaining machine used to generate the game of chance and operate the gaming machine has been designed to be static and monolithic to prevent cheating by the operator of gaming machine. For instance, one solution that has been employed in the gaming industry to prevent cheating and satisfy regulatory requirements has been to manufacture a gaming machine that can use a proprietary processor running instructions to generate the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used by the master gaming controller to operate a device during generation of the game of chance can require a new EPROM to be burnt, approved by the gaming jurisdiction and reinstalled on the gaming machine in the presence of a gaming regulator. Regardless of whether the EPROM solution is used, to gain approval in most gaming jurisdictions, a gaming machine must demonstrate sufficient safeguards that prevent an operator or player of a gaming machine from manipulating hardware and software in a manner that gives them an unfair and some cases an illegal advantage. The gaming machine should have a means to determine if the code it will execute is valid. If the code is not valid, the gaming machine must have a means to prevent the code from being executed. The code validation requirements in the gaming industry affect both hardware and software designs on gaming machines.

A third important difference between gaming machines and common PC based computer systems is the number and kinds of peripheral devices used on a gaming machine are not as great as on PC based computer systems. Traditionally, in the gaming industry, gaming machines have been relatively simple in the sense that the number of peripheral devices and the number of functions the gaming machine has been limited. Further, in operation, the functionality of gaming machines were relatively constant once the gaming machine was deployed, i.e., new peripherals devices and new gaming software were infrequently added to the gaming machine. This differs from a PC where users will go out and buy different combinations of devices and software from different manufacturers and connect them to a PC to suit their needs depending on a desired application. Therefore, the types of devices connected to a PC may vary greatly from user to user depending in their individual requirements and may vary significantly over time.

Although the variety of devices available for a PC may be greater than on a gaming machine, gaming machines still have unique device requirements that differ from a. PC, such as device security requirements not usually addressed by PCs. For instance, monetary devices, such as coin dispensers, bill validators and ticket printers and computing devices that are used to govern the input and output of cash to a gaming machine have security requirements that are not typically addressed in PCs. Therefore, many PC techniques and methods developed to facilitate device connectivity and device compatibility do not address the emphasis placed on security in the gaming industry.

To address some of the issues described above, a number of hardware/software components and architectures are utilized in gaming machines that are not typically found in general purpose computing devices, such as PCs. These hardware/software components and architectures, as described below in more detail, include but are not limited to watchdog timers, voltage monitoring systems, state-based software architecture and supporting hardware, specialized communication interfaces, security monitoring and trusted memory.

A watchdog timer is normally used in gaming machines to provide a software failure detection mechanism. In a normally operating system, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits contain a loadable timeout counter register to allow the operating software to set the timeout interval within a certain range of time. A differentiating feature of some preferred circuits is that the operating software cannot completely disable the function of the watchdog timer. In other words, the watchdog timer always functions from the time power is applied to the board.

Gaming computer platforms preferably use several power supply voltages to operate portions of the computer circuitry. These can be generated in a central power supply or locally on the computer board. If any of these voltages falls out of the tolerance limits of the circuitry they power, unpredictable operation of the computer may result. Though most modem general-purpose computers include voltage monitoring circuitry, these types of circuits only report voltage status to the operating software. Out of tolerance voltages can cause software malfunction, creating a potential uncontrolled condition in the gaming computer. Gaming machines typically have power supplies with tighter voltage margins than that required by the operating circuitry. In addition, the voltage monitoring circuitry implemented in gaming computers typically has two thresholds of control. The first threshold generates a software event that can be detected by the operating software and an error condition generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the computer.

The standard method of operation for slot machine game software is to use a state machine. Different functions of the game (bet, play, result, points in the graphical presentation, etc.) may be defined as a state. When a game moves from one state to another, critical data regarding the game software is stored in a custom non-volatile memory subsystem. This is critical to ensure the player's wager and credits are preserved and to minimize potential disputes in the event of a malfunction on the gaming machine.

In general, the gaming machine does not advance from a first state to a second state until critical information that allows the first state to be reconstructed is stored. This feature allows the game to recover operation to the current state of play in the event of a malfunction, loss of power, etc. that occurred just prior to the malfunction. After the state of the gaming machine is restored during the play of a game of chance, game play may resume and the game may be completed in a manner that is no different than if the malfunction had not occurred. Typically, battery backed RAM devices are used to preserve this critical data although other types of non-volatile memory devices may be employed. These memory devices are not used in typical general-purpose computers.

As described in the preceding paragraph, when a malfunction occurs during a game of chance, the gaming machine may be restored to a state in the game of chance just prior to when the malfunction occurred. The restored state may include metering information and graphical information that was displayed on the gaming machine in the state prior to the malfunction. For example, when the malfunction occurs during the play of a card game after the cards have been dealt, the gaming machine may be restored with the cards that were previously displayed as part of the card game. As another example, a bonus game may be triggered during the play of a game of chance where a player is required to make a number of selections on a video display screen. When a malfunction has occurred after the player has made one or more selections, the gaming machine may be restored to a state that shows the graphical presentation at the just prior to the malfunction including an indication of selections that have already been made by the player. In general, the gaming machine may be restored to any state in a plurality of states that occur in the game of chance that occurs while the game of chance is played or to states that occur between the play of a game of chance.

Game history information regarding previous games played such as an amount wagered, the outcome of the game and so forth may also be stored in a non-volatile memory device. The information stored in the non-volatile memory may be detailed enough to reconstruct a portion of the graphical presentation that was previously presented on the gaming machine and the state of the gaming machine (e.g., credits) at the time the game of chance was played. The game history information may be utilized in the event of a dispute. For example, a player may decide that in a previous game of chance that they did not receive credit for an award that they believed they won. The game history information may be used to reconstruct the state of the gaming machine prior, during and/or after the disputed game to demonstrate whether the player was correct or not in their assertion.

Another feature of gaming machines, such as gaming computers, is that they often contain unique interfaces, including serial interfaces, to connect to specific subsystems internal and external to the slot machine. The serial devices may have electrical interface requirements that differ from the “standard” EIA 232 serial interfaces provided by general-purpose computers. These interfaces may include EIA 485, EIA 422, Fiber Optic Serial, optically coupled serial interfaces, current loop style serial interfaces, etc. In addition, to conserve serial interfaces internally in the slot machine, serial devices may be connected in a shared, daisy-chain fashion, where multiple peripheral devices are connected to a single serial channel.

The serial interfaces may be used to transmit information using communication protocols that are unique to the gaming industry. For example, the Netplex™ system of IGT is a proprietary communication protocol used for serial communication between gaming devices. As another example, SAS is a communication protocol used to transmit information, such as metering information, from a gaming machine to a remote device. Often SAS is used in conjunction with a player tracking system.

Gaming machines may alternatively be treated as peripheral devices to a casino communication controller and connected in a shared daisy chain fashion to a single serial interface. In both cases, the peripheral devices are preferably assigned device addresses. If so, the serial controller circuitry must implement a method to generate or detect unique device addresses. General-purpose computer serial ports are not able to do this.

Security monitoring circuits detect intrusion into a gaming machine by monitoring security switches attached to access doors in the slot machine cabinet. Preferably, access violations result in suspension of game play and can trigger additional security operations to preserve the current state of game play. These circuits also function when power is off by use of a battery backup. In power-off operation, these circuits continue to monitor the access doors of the slot machine. When power is restored, the gaming machine can determine whether any security violations occurred while power was off, e.g., via software for reading status registers. This can trigger event log entries and further data authentication operations by the slot machine software.

Trusted memory devices are preferably included in a gaming machine computer to ensure the authenticity of the software that may be stored on less secure memory subsystems, such as mass storage devices. Trusted memory devices and controlling circuitry are typically designed to not allow modification of the code and data stored in the memory device while the memory device is installed in the slot machine. The code and data stored in these devices may include authentication algorithms, random number generators, authentication keys, operating system kernels, etc. The purpose of these trusted memory devices is to provide gaming regulatory authorities a root trusted authority within the computing environment of the slot machine that can be tracked and verified as original. This may be accomplished via removal of the trusted memory device from the slot machine computer and verification of the secure memory device contents is a separate third party verification device. Once the trusted memory device is verified as authentic, and based on the approval of the verification algorithms contained in the trusted device, the gaming machine is allowed to verify the authenticity of additional code and data that may be located in the gaming computer assembly, such as code and data stored on hard disk drives. A few details related to trusted memory devices that may be used in the present invention are described in U.S. Pat. No. 6,685,567 titled “Process Verification,” which is incorporated herein in its entirety and for all purposes.

Mass storage devices used in a general purpose computer typically allow code and data to be read from and written to the mass storage device. In a gaming machine environment, modification of the gaming code stored on a mass storage device is strictly controlled and would only be allowed under specific maintenance type events with electronic and physical enablers required. Though this level of security could be provided by software, gaming computers that include mass storage devices preferably include hardware level mass storage data protection circuitry that operates at the circuit level to monitor attempts to modify data on the mass storage device and will generate both software and hardware error triggers should a data modification be attempted without the proper electronic and physical enablers being present.

Returning to the example of FIG. 1, when a user wishes to play the gaming machine 2, he or she inserts cash through the coin acceptor 28 or bill validator 30. Additionally, the bill validator may accept a printed ticket voucher which may be accepted by the bill validator 30 as an indicia of credit when a cashless ticketing system is used. At the start of the game, the player may enter playing tracking information using the card reader 24, the keypad 22, and the florescent display 16. Further, other game preferences of the player playing the game may be read from a card inserted into the card reader. During the game, the player views game information using the video display 34. Other game and prize information may also be displayed in the video display screen 42 located in the top box.

During the course of a game, a player may be required to make a number of decisions, which affect the outcome of the game. For example, a player may vary his or her wager on a particular game, select a prize for a particular game selected from a prize server, or make game decisions which affect the outcome of a particular game. The player may make these choices using the player-input switches 32, the video display screen 34 or using some other device which enables a player to input information into the gaming machine. In some embodiments, the player may be able to access various game services such as concierge services and entertainment content services using the video display screen 34 and one more input devices.

During certain game events, the gaming machine 2 may display visual and auditory effects that can be perceived by the player. These effects add to the excitement of a game, which makes a player more likely to continue playing. Auditory effects include various sounds that are projected by the speakers 10, 12, 14. Visual effects include flashing lights, strobing lights or other patterns displayed from lights on the gaming machine 2 or from lights within the separate mechanical (or electronic) separately, individually wagerable gaming system 40. After the player has completed a game, the player may receive game tokens from the coin tray 38 or the ticket 20 from the printer 18, which may be used for further games or to redeem a prize. Further, the player may receive a ticket 20 for food, merchandise, or games from the printer 18.

Although the invention has been described in detail with reference to several embodiments, additional variations and modifications exist within the scope and spirit of the invention as described and defined in the following claims.

1. A method of executing a wagering event including multiple poker games on an electronic gaming machine comprising:
providing an electronic gaming machine comprising a housing, video display, player input controls, a processor associated with memory, and wherein the player input controls include a value-in-value out component selected from the group consisting of a ticket-in-ticket out system having a ticket reader and a ticket printer with a motor to accept and deliver tickets, and a currency reader with a motor to accept and deliver currency;
the processor accepting at least a predetermined minimum allowable individual first wager on a multiple number of individual poker wagering events;
the processor providing each individual poker wagering event displayed on the video display with identical sets of five random virtual playing cards forming an initial five-card virtual hand identical for each of the multiple number of individual poker wagering events, and displaying such individual initial five-card virtual hands face-up for at least one such individual poker wagering event for each hand on which wagers are placed;
the processor retaining in memory at least until conclusion of the wagering event the values of these initial five random virtual playing cards;
the player identifying through the player input controls which virtual playing cards from the identical sets of five random virtual playing cards are to be maintained to form an initial partial virtual playing card hand and which other virtual playing cards from the identical sets of five random virtual playing cards are to be discarded and replaced by first random virtual replacement playing cards from individual residual virtual playing card sets from which the five initial random virtual playing cards have been excluded, to form first initial final poker hands,
the processor resolving each wager on each of the multiple poker game initial final poker hand ranks against a paytable;
if a subset of the initial random virtual playing cards in the individual initial playing card hands are recognized by the processor as comprising one or more pre-established poker hand ranks or four of five virtual playing cards necessary to form a straight flush, that recognition enables a second deal, discard and draw event for the multiple number of individual poker wagering events of five virtual playing cards identical to the virtual playing cards in the initial five-card virtual hand;
upon initiation of the second deal, discard and draw event by the player, the processor provides each individual original poker wagering event displayed on the video display with a second initial five-card virtual hand with identical suit and rank values of the initial five random virtual playing cards retained in memory, and displays such individual initial five-card virtual hands face-up for at least one such individual poker wagering event for each hand on which wagers in the first deal, discard and draw event have been placed;
the player identifying through the player input controls or the processer duplicates the identified virtual playing cards maintained in the initial five random virtual playing cards which virtual playing cards from the identical sets of five random virtual playing cards are to be maintained to form a second partial virtual playing card hand and which virtual playing cards from the second initial five-card virtual hand are to be discarded and replaced by second random virtual replacement playing cards from individual residual virtual playing card sets from which the five initial random virtual playing cards have been excluded to form second final poker hands,
and the processor resolving all second final poker hands by providing a second payout against a paytable on each of the multiple numbers of second final poker hands based on a rank of all second final poker hands.

2. The method of claim 1 wherein there is a single pay table available for resolution of all wagers in the first final poker hands and the second final poker hands.

3. The method of claim 1 wherein a predetermined minimum wager amount is needed on each individual wagering event to enable triggering of the second deal, discard and draw event.

4. The method of claim 1 wherein all of the original number of individual wagering events are offered in the second deal, discard and draw event when the predetermined minimum wager amount is 5× or 6× the predetermined minimum allowable individual first wager.

5. The method of claim 1 wherein one or more of the original wagering events is excluded by the processor from the second deal, discard and draw event.

6. The method of claim 1 wherein the second deal, discard and draw event is enabled for the initial identical five-card virtual poker hands that contain two pairs, three-of-a-kind and not a full house, and four cards enabling a straight flush including a royal straight flush.

7. The method of claim 1 wherein the second deal, discard and draw event is enabled for the initial identical five virtual poker hands that contain three-of-a-kind and at least one and fewer than 20% of the first final poker hands are a four-of-a-kind.

8. The method of claim 1 wherein the second deal, discard and draw event is enabled for the initial identical five-card virtual poker hands that contain four out of five cards comprising a straight flush and at least one final poker hand rank and fewer than 20% of the first final poker hand ranks are a straight flush.

9. The method of claim 1 wherein the second deal, discard and draw event is enabled for the initial identical virtual poker hands that are four out of five cards comprising a royal straight flush and at least one first final poker hand rank is a royal straight flush.

10. The method of claim 6 wherein the one or more pre-established poker hand ranks are selected from the group consisting of two pairs, three-of-a-kind and four out of five cards enabling a straight flush including a royal straight flush.

11. The method of claim 1 further comprising requiring the player to place a second wager at least equal to the predetermined minimum allowable individual first wager but less than a maximum allowable wager.

12. The method of claim 11 wherein the second deal, discard and draw event may be exercised only when a predetermined number of the multiple number of hands in the multiple individual wagering events in excess of zero hands exceeds the one or more pre-established poker hand ranks.

13. The method of claim 12 wherein the one or more pre-established poker hand ranks are selected from the group consisting of two pairs, three-of-a-kind and four out of five cards enabling a straight flush including a royal straight flush.

14. A method of executing a wagering event including one or a number of multiple poker games on an electronic gaming machine comprising:
providing an electronic gaming machine comprising a housing, video display, player input controls, a processor associated with memory, and wherein the player input controls include a value-in-value out component selected from the group consisting of a ticket-in-ticket out system having a ticket reader and a ticket printer with a motor to accept and deliver tickets, and a currency reader with a motor to accept and deliver currency;
the processor accepting individual first wagers on the one or the number of multiple number of individual poker wagering events;
the processor providing each individual poker wagering event displayed on the display screen with identical sets of five random face-up virtual playing cards forming an initial five-card virtual hand;
the processor executing a first discard and draw event with the player retaining exactly three of four virtual playing cards from the identical sets of five random face-up virtual playing cards to form first final replacement poker hands;
if the random face-up virtual playing cards in the one or the number of multiple poker hands of five random face-up virtual playing cards are recognized by the processor as comprising one or more pre-established poker hand ranks or four of five virtual playing cards necessary to form a straight flush, the processor triggers a second discard and draw event for the one or the number of multiple individual poker wagering events;
the processor discarding and replacing each virtual playing card that is superfluous to the one or more pre-established poker hand ranks or four of five virtual playing cards necessary to form a straight flush of the provided random virtual playing cards in the one or the number of multiple poker hands of five random face-up virtual playing cards so that the recognized pre-established poker hand ranks remains in each of the individual poker wagering events and forming virtual first final replacement hands;
the processor replacing each discard with second new random virtual playing cards from individual residual virtual playing card sets from which individual playing cards from which the five random virtual playing cards have been excluded, forming virtual second final replacement poker hands; and
the processor resolving all wagers by providing a payout on each of the multiple numbers of replacement hands from a poker pay table to a player credit storage managed by the processor based on a rank of at least one of the first final replacement poker hands and the second final replacement poker hands.

15. The method of claim 14 wherein there are a number of multiple poker games and there is a single pay table available for resolution of all wagers in the first final replacement hands and the second final replacement poker hands and the individual first wagers are 6-times a minimum acceptable wager, and the maximum payout in the paytable is based on wagers that are 5-times the minimum acceptable wager.

16. The method of claim 15 wherein the second discard and draw activity may be exercised only when a predetermined number of the multiple number of hands in the multiple individual wagering events in excess of zero hands exceeds the one or more pre-established poker hand ranks, and wherein there is a single pay table available for resolution of all wagers in the first final replacement hand and the second final replacement poker hands and the individual first wagers are 6-times a minimum acceptable wager, and the maximum payout in the paytable is based on wagers that are 5-times the minimum acceptable wager.

17. The method of claim 16 wherein the one or more pre-established poker hand ranks are selected from the group consisting of two pairs, three-of-a-kind and four out of five cards enabling a straight flush including a royal straight flush.

18. The method of claim 1 wherein only if all wagers made on the multiple number of individual poker wagering events meet or exceed a pre-determined threshold, and only if the random initially dealt virtual playing cards are recognized by the processor as comprising the one or more pre-established poker hand ranks is the second deal, discard and draw opportunity enabled for some or all of the multiple number of individual poker wagering events results, and wherein there is a single pay table available for resolution of all wagers in the first final replacement hands and the second final replacement poker hands and the individual first wagers are 6-times a minimum acceptable wager, and the maximum payout in the paytable is based on wagers that are 5-times the minimum acceptable wager.

19. The method of claim 18 wherein executing the second deal, discard and draw event requires either no additional wagers or a second wager that is less than the wager that meets or exceeds the pre-determined threshold.

20. The method of claim 16 wherein in the execution of the second discard and draw event, the processor provides some or all of the individual poker wagering event displayed on the display screen with the same identical sets of five random virtual playing cards forming an initial five-card virtual hand identical to that forming the initial five-card virtual hand, and the processor displaying such initial five-card virtual hands face-up for at least one second individual poker wagering event for each hand on which wagers are placed.

21. A method of executing a wagering event including multiple poker games on an electronic gaming machine comprising:
providing an electronic gaming machine comprising a housing, video display, player input controls, a processor associated with memory, and wherein the player input controls include a value-in-value out component selected from the group consisting of a ticket-in-ticket out system having a ticket reader and a ticket printer with a motor to accept and deliver tickets, and a currency reader with a motor to accept and deliver currency;
the processor accepting at least a predetermined minimum allowable individual first wager on a multiple number of individual poker wagering events;
the processor providing each individual poker wagering event displayed on the video display with identical sets of five random virtual playing cards forming an initial five-card virtual hand identical for each of the multiple number of individual poker wagering events, and displaying such individual initial five-card virtual hands face-up for at least one such individual poker wagering event for each hand on which wagers are placed;
the player identifying through the player input controls which virtual playing cards from the identical sets of five random virtual playing cards are to be maintained to form an initial partial virtual playing card hand and the processor retaining in memory at least until conclusion of the wagering event the values of the initial partial virtual playing card hand;
the processor replacing the discarded first random virtual playing cards with replacement playing cards from individual residual virtual playing card sets from which the five initial random virtual playing cards have been excluded, to form first initial final poker hands, the processor resolving each wager on each of the multiple poker game initial final poker hands against a paytable;
if a subset of the initial random virtual playing cards in the individual initial playing card hands are recognized by the processor as comprising one or more pre-established poker hand ranks or orders of 3 or 4 virtual playing cards, that recognition enables a second deal, discard and draw event for the multiple number of individual poker wagering events;
upon initiation of the second deal, discard and draw event by the player, the processor providing to all of the multiple wagering events identical 3 or 4 card second initial virtual playing card hands formed by combining the retained 3 or 4 virtual playing cards that form one or more pre-established poker hand ranks or orders, and displaying such individual initial second initial virtual playing cards face-up for at least one such individual poker wagering event for each hand on which wagers in the first deal, discard and draw event are placed;
the processor automatically providing 2 or 1 additional random virtual playing cards to complete the 2 or 4 second initial playing card hands with second random virtual replacement playing cards from individual residual virtual playing card sets from which the five first initial random virtual playing cards have been excluded, and
the processor thus forming second final poker hands and the processor resolving all second final poker hands by providing a second payout against a paytable on each of the multiple numbers of second final poker hands based on a rank of all second final poker hands.

22. The method of claim 21 wherein the one or more pre-established poker hand ranks or orders of 3 or 4 virtual playing cards are selected from the group consisting of three-of-a-kind and four-of-five playing cards necessary for a straight flush, and wherein there is a single pay table available for resolution of all wagers in the first final replacement hands and the second final replacement poker hands and the individual first wagers are 6-times a minimum acceptable wager, and the maximum payout in the paytable is based on wagers that are 5-times the minimum acceptable wager.
